(19) United States
(12) Patent Application Publication
(10) Pub. No.: US 2002/0146360 A1
(43) Pub. Date: Oct. 10, 2002

(54) Honeycomb body having a multilayer shell

(76) Inventor: Rolf Bruck, Bergisch Gladbach (DE)

Correspondence Address: LEARNER AND GREENBERG, P.A., Post Office Box 2480, Hollywood, FL, 33022-2480, US

(21) Appl. No.: 10/134,944

(22) Filed: Apr. 29, 2002

Related U.S. Application Data
(63) Continuation of application No. PCT/EP00/10431, filed on Oct. 23, 2000.

(30) Foreign Application Priority Data
Oct. 28, 1999 (DE) 199 51 941.2

(51) Int. Cl. B01J 8/02; B01J 8/04; B01J 8/06

(52) U.S. Cl. 422/211; 422/218; 422/222

(57) ABSTRACT

A honeycomb body, in particular a catalyst carrier body, includes a carrier matrix shell for a carrier matrix formed of partially structured, layered and/or wound or folded metal sheets. The carrier matrix has a plurality of passages which are fluid-permeable and extend substantially parallel to a central longitudinal axis. The carrier matrix shell has at least two individual, smooth layers, preferably with substantially the same thickness, disposed concentrically relative to one another and at least two of the layers are adjacent one another. In addition to an improved ability to compensate for expansion of a thermal origin, the honeycomb body has vibration damping and sound-proofing qualities, resulting from the multi-layer structure of the carrier matrix shell.

### CROSS-REFERENCE TO RELATED APPLICATION

This application is a continuation of copending International Application No. PCT/EP00/10431, filed Oct. 23, 2000, which designated the United States and was not published in English.

### BACKGROUND OF THE INVENTION

Field of the Invention

The invention relates to a honeycomb body, in particular a catalyst carrier body, with a carrier matrix which is layered and/or wound or folded from at least partially structured metal foils and has a multiplicity of passages through which a fluid can flow. The passages are substantially parallel to a central longitudinal axis. The honeycomb body also has a multilayer shell.

Mechanical vibrations may occur in a carrier matrix which is disposed in a shell of a honeycomb body, as a result of various excitation mechanisms. For example, in the case of a honeycomb body which is used as a catalyst carrier body and is disposed in the exhaust system of an internal combustion engine, transverse vibrations of the carrier-matrix shell may be caused by pulsed exhaust gas or other vibrations. In particular, in the event of resonant oscillations, a connection between the carrier-matrix shell and the carrier matrix may be damaged or destroyed. Therefore, it has been attempted to provide the connection between the carrier-matrix shell and the carrier matrix in such a way that, when the catalyst carrier body which is exposed to the above-mentioned vibrations is in use, the connections between the shell and the carrier matrix are as durable as possible, for example by reinforcing the shell. However, even those reinforced carrier-matrix shells which are produced from a single layer tend to ring like a bell in the event of an impact and therefore, in addition to poor vibration-damping properties, also emit relatively large amounts of sound.

Furthermore, thick carrier-matrix shells have considerable drawbacks with regard to securing thin metal foils to the carrier matrix, and the trend is toward increasingly thin foils. Therefore, if it is desired to produce a durable connection, in particular through the use of a joining technique, between the carrier matrix and the housing, it is necessary in particular for a welding depth, for example of an electron or laser beam, to be set highly accurately. That is because otherwise, the outer metal foils of the carrier matrix can be cut into during welding or are not secured correctly, so that the welded joint between the housing and the carrier matrix becomes unstable over the course of time.

For example, in order to solve the above-mentioned problem, European Patent Application 0 509 207 A1, corresponding to U.S. Pat. Nos. 5,366,700; 5,502,023; and 5,797,183, has disclosed a honeycomb body including a plurality of layers of corrugated and/or smooth sheets which are stacked on top of one another and interwoven and have smooth, overlapping end sections. The overlapping end sections have an outer layer at the periphery of the carrier matrix which is selected in such a way that it is greater than the wall thickness of the shell surrounding it and therefore can be connected, in particular welded, to the shell without difficulties. However, in addition to the above-mentioned vibration and sound problems, a further drawback which runs counter to that advantage of simple and permanent welding of the shell or shell tube to the carrier matrix formed in that way, is that the carrier matrix and the shell which surrounds it cannot undergo different levels of thermal expansion with respect to one another, in particular in the axial direction. As a result, when the honeycomb body is operating, stresses which may lead to premature destruction occur.

A carrier-matrix shell of a honeycomb body, which absorbs the above-mentioned vibrations somewhat better, is known, for example, from German Published, Non-Prosecuted Patent Application DE 28 56 030 A1, corresponding to U.S. Pat. Nos. 4,400,860 and 4,519,120. According to that prior art, a carrier matrix is surrounded by a slotted, open hollow cylindrical shell which is produced from a planar piece of sheet metal of appropriate size by rolling-up that piece of metal. Then, the carrier matrix is introduced into the slotted, open hollow cylindrical shell with play and is then placed between two tools and compressed. Therefore, an overlap or, depending on the dimensions and layout of the shell, a butt joint, is produced in the region of the slot, which is then welded.

Furthermore, U.S. Pat. No. 5,190,732 has disclosed a honeycomb body configuration in which the carrier matrix is surrounded by a shell. For its part, the shell is disposed in a separate, concentrically disposed tubular shell, substantially at a distance from the latter, i.e. for example with air gap insulation.

Finally, reference is also made to multilayer carrier-matrix shells which are known, for example, from International Publication No. WO 93/11934, corresponding to U.S. Pat. No. 5,514,348, and include a plated steel sheet which is provided on one side of a base material, that forms a middle layer and includes a first stainless steel, and on the other side has a base made from a second stainless steel, which is different from the first stainless steel. The layer thicknesses of the substrates are generally only approximately 10% of the total sheet-metal thickness. Even if plated steel sheets can be adapted in particular to conditions of use which are exposed to hot gas and wet corrosion, they do not have good vibration and/or sound-absorbing properties. In addition, the layers cannot expand differently in the axial direction.

### SUMMARY OF THE INVENTION

It is accordingly an object of the invention to provide a honeycomb body having an improved carrier-matrix shell, which overcomes the hereinafore-mentioned disadvantages of the heretofore-known devices of this general type, which in particular has good vibration and sound-damping properties, in which components of the honeycomb body are able to expand by different amounts, in particular in longitudinal axial direction, without being to the detriment of simple and permanent securing of a carrier matrix to the shell and in which the honeycomb body has a carrier-matrix shell that allows simplified securing of the carrier matrix to the shell. With the foregoing and other objects in view there is provided, in accordance with the invention, a honeycomb body, in particular a catalyst carrier body, comprising a central longitudinal axis. A carrier matrix is layered and/or wound or folded from at least partially structured metal foils. The carrier matrix has a multiplicity of fluid-conducting passages substantially parallel to the central longitudinal axis. A carrier-matrix shell for the carrier matrix has at least two individual, smooth, mutually concentric layers. The layers include at least two layers bearing directly against one another. The layers are only regionally interconnected, permitting expansion of the layers by mutually different amounts, in particular in longitudinal axial direction. The layers are individually connected to one another by a joining technique, at least in a partial region located substantially at a location otherwise having the highest vibrational amplitudes.

The invention is based on the concept that carrier-matrix shells, which are produced from a single layer, for a honeycomb body, in particular a catalyst carrier body, and are provided for a carrier matrix which is layered and/or wound or folded from at least partially structured metal foils and has a multiplicity of passages, through which a fluid can flow and which are substantially parallel to a central longitudinal axis, are relatively rigid and vibrate substantially without damping. That is evident from the fact that they ring like a bell when struck. Carrier-matrix shells which are produced from at least two, and preferably three or more, individual, smooth layers that are disposed concentrically with respect to one another and preferably have substantially the same thickness, and of which at least two layers bear directly against one another, damp vibrations and sound to a much greater extent. Such shells can easily be produced, for example by placing a plurality of layers of steel on top of one another or by rolling.

As mentioned above, the layers of the carrier-matrix shell are connected to one another in such a way that they can expand by different amounts in particular in the longitudinal axial direction. This advantageously avoids thermal stresses and ensures a long product service life.

In accordance with another feature of the invention, the metal foils are connected through their ends, in particular by joining, only at the innermost layer of the carrier-matrix shell in at least one connecting section which preferably lies adjacent the fluid inlet-side end of the honeycomb body.

In accordance with a further feature of the invention, in particular to avoid a telescopic action on the part of the carrier matrix, the ends of the metal foils are additionally connected to the innermost layer in a connecting section which lies adjacent the fluid outlet-side end of the honeycomb body.

In accordance with an added feature of the invention, the honeycomb body overall has only a short axial length, for example less than 60 mm and preferably only about 30 mm, and the ends of the metal foils are also connected to the innermost layer of the carrier-matrix shell over their entire axial length. This advantageously simplifies production thereof.

In accordance with an additional feature of the invention, the layers of the carrier-matrix shell, at least in partial regions, are predominantly connected to one another by a joining technique, in particular by welding, brazing or adhesive bonding.

In accordance with yet another feature of the invention, in a first configuration, the innermost layer of the carrier-matrix shell is connected to the next outer layer of the carrier-matrix shell, and/or the latter layer is in turn connected to the next outer layer of the carrier-matrix shell in a connecting section which is disposed symmetrically with respect to the longitudinal axis and, for example, runs all the way around in the peripheral direction, and preferably lies approximately in the central region of the honeycomb body.

In accordance with yet a further feature of the invention, alternatively, the innermost layer of the carrier-matrix shell is connected to the next outer layer of the carrier-matrix shell, and/or the latter layer is connected to the next outer layer of the carrier-matrix shell in one or more connecting sections which are disposed asymmetrically with respect to the longitudinal axis and in particular run in a spiral or helically. Symmetrical and asymmetrical connecting sections or, if appropriate, only partial sections thereof, may also alternate between a plurality of adjacent layers. The term “asymmetric configuration” is to be understood as meaning that at no point on any plane perpendicular to the longitudinal axis of the honeycomb body are there connecting sections with the same asymmetrical connection which lie opposite one another, offset by approximately 180° with respect to the longitudinal axis. This asymmetric configuration of the connecting sections, in which the connection between layers of the carrier-matrix shell is produced, firstly ensures a sufficient connection strength between adjacent layers, in particular provided that these connections are located substantially at locations at which the highest vibration amplitudes otherwise occur. Secondly, the carrier-matrix shell of a honeycomb body of this type advantageously has a sufficiently high strength to be able to absorb thermal loads, in particular caused by temperature differences.

In accordance with yet an added feature of the invention, in order to improve the capacity for thermal expansion in the axial direction, the connecting sections disposed between the layers of the carrier-matrix shell lie as far as possible away from, i.e. are separate from, the connecting sections of the carrier matrix to the innermost layer.

In accordance with yet an additional feature of the invention, with the exception of the innermost layer, the layers are connected to one another in a form-locking manner, preferably through the use of at least one bead in each case, and the layers which have been connected in this manner are connected to the innermost layer through the use of a joining technique. A form-locking connection is one which connects two elements together due to the shape of the elements themselves, as opposed to a force-locking connection, which locks the elements together by force external to the elements.

In accordance with again another feature of the invention, all of the layers of the carrier-matrix shell are connected to one another in a form-locking manner, preferably through the use of at least one bead in each case.

In accordance with again a further feature of the invention, for damping vibrations and sound, there is provided a thin interlayer, which is approximately 0.5 to 0.8 mm thick and preferably is formed of a ceramic material, in particular a swellable mat. The interlayer is disposed, in particular, between the two outermost layers of the carrier-matrix shell.

In accordance with again an added feature of the invention, alternatively, there is provided a compensator, which has a loop-shaped structure in axial longitudinal section, and is disposed in particular between the two outermost layers of the carrier-matrix shell.

In accordance with again an additional feature of the invention, the layers have a thickness of less than 1.5 times the thickness of the metal foils, in particular less than 1.25 times the thickness of the metal foils, and preferably approximately the same as the metal foils. This is particularly advantageous for ensuring that the layers of the carrier-matrix shell have approximately the same thermal expansion characteristics as the metal foils of the carrier matrix.

In accordance with still another feature of the invention, working on the basis of current metal foil thicknesses, the layers have a thickness of less than or equal to 0.05 mm, in particular less than or equal to 0.04 mm and preferably less than or equal to 0.03 mm.

In accordance with still a further feature of the invention, in order to provide simplified securing of the end sides of the honeycomb body to a cone, it is proposed for the outermost layer to be slightly longer in the axial direction than the inner layers of the carrier-matrix shell.

In accordance with still an added feature of the invention, alternatively, the carrier-matrix shell has layers which are constructed to be of equal length. In this case at least the outermost layer has a securing bead at the end side in each case, so that the securing of a cone, preferably using a joining technique, is advantageously facilitated.

In accordance with still an additional feature of the invention, the cone has a wall thickness which is such that the carrier-matrix shell, which is constructed from layers, is covered at the end side.

In accordance with a concomitant feature of the invention, in order to increase the service life of the product, the innermost layer of the carrier-matrix shell is formed of a stainless steel which is resistant to corrosion from hot gases or at least is coated or plated on the inner side with such a material, and/or the outermost layer of the carrier-matrix shell is formed of a stainless steel which is resistant to wet corrosion or at least is coated or plated on the outer side with such a material. It is also possible to take into account the fact that the outermost layer is exposed not only to wet corrosion but also to mechanical loads through the action of stones or sand or the like.

Other features which are considered as characteristic for the invention are set forth in the appended claims.

Although the invention is illustrated and described herein as embodied in a honeycomb body having a multilayer shell it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a highly diagrammatic, end-elevational view of a honeycomb body according to the invention, in particular a catalyst carrier body, having a two-layer carrier-matrix shell;

FIG. 2 is an enlarged, partly-sectional, end-elevational view showing further details of the honeycomb body according to the invention shown in FIG. 1;

FIG. 3 is a highly diagrammatic, end-elevational view of a honeycomb body according to the invention having a three-layer carrier-matrix shell;

FIG. 4 is a side-elevational view of the honeycomb body according to the invention shown in FIGS. 1 and 2, with symmetrically secured layers;

FIG. 5 is a perspective view of the honeycomb body according to the invention shown in FIGS. 1 and 2, with asymmetrically secured layers;

FIGS. 6 and 7 are side-elevational views of further alternative embodiments for securing the layers of the carrier-matrix shell to one another;

FIG. 8 is a side-elevational view of a carrier-matrix shell which has an interlayer;

FIG. 9 is a side-elevational view of a carrier-matrix shell which has a compensator; and

FIGS. 10 and 11 are longitudinal-sectional views of a four-layer carrier-matrix shell with a cone disposed thereon.

### DESCRIPTION OF THE PREFERRED EMBODIMENTS

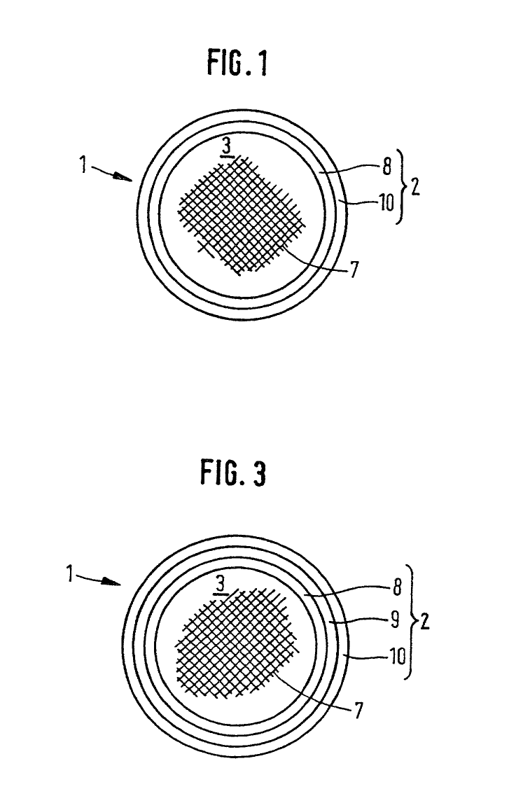

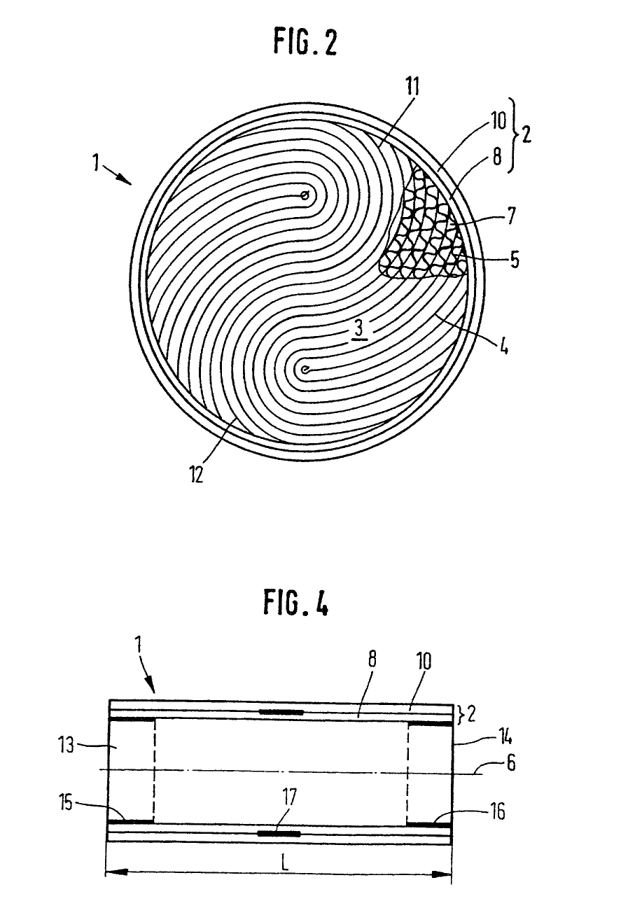

Referring now to the figures of the drawings in detail and first, particularly, to FIG. 1 thereof, there is seen a highly diagrammatic illustration of a honeycomb body 1 according to the invention, in particular a catalyst carrier body, including a carrier-matrix shell 2 for a carrier matrix 3 which is layered and/or wound or folded from at least partially structured metal foils 4, 5 (shown in FIG. 2) and has a multiplicity of passages 7 through which a fluid can flow. According to the exemplary embodiment shown in FIG. 1, the carrier-matrix shell 2 is constructed from two separate, smooth innermost and outer layers 8, 10 which are disposed concentrically with respect to one another, have substantially the same thickness and bear directly against one another. Further details of the honeycomb body 1 shown in FIG. 1, in particular a third S-shaped configuration of the metal foils 4, 5, are illustrated in FIG. 2.

The carrier-matrix shell 2 may also be composed of three layers 8, 9, 10, as is diagrammatically illustrated in FIG. 3, or of even more than three layers. The layers 8, 9, 10 of the carrier-matrix shell 2 are connected to one another in such a way that they can expand to different extents, in particular in axial direction. This firstly requires the metal foils 4, 5 to be connected at their ends 11, 12 only at the innermost layer 8 of the carrier-matrix shell 2, in at least one connecting section 15 which preferably lies adjacent a fluid inlet-side end 13 of the honeycomb body 1, as is illustrated in FIG. 4.

FIG. 4 also shows that, in particular in order to avoid a telescopic action on the part of the carrier matrix 3, the ends 11, 12 of the metal foils 4, 5 are additionally connected to the innermost layer 8 in a connecting section 16 which is adjacent a fluid outlet-side end 14 of the honeycomb body 1.

If the honeycomb body 1 has only a short axial length (L) of, for example, only L=25 mm or L=35 mm, in a non-illustrated embodiment the ends 11, 12 of the metal foils 4, 5 may also be connected to the innermost layer 8 of the carrier-matrix shell 2 over their entire axial length (L). The layers 8, 9, 10 of the carrier-matrix shell 2 are preferably connected to one another predominantly through the use of a joining technique, in particular by welding, brazing or adhesive bonding.

FIG. 4 also shows that the innermost layer 8 of the carrier-matrix shell 2 is connected to the next outer layer, which in the exemplary embodiment is in fact the outermost layer 10 of the carrier-matrix shell 2. The connection is provided in a connecting section 17 which is disposed symmetrically with respect to a longitudinal axis 6 of the honeycomb body 1 and preferably lies approximately in a central region of the honeycomb body 1. This connection technique can, of course, also be applied to three-layer or multilayer carrier-matrix shells 2.

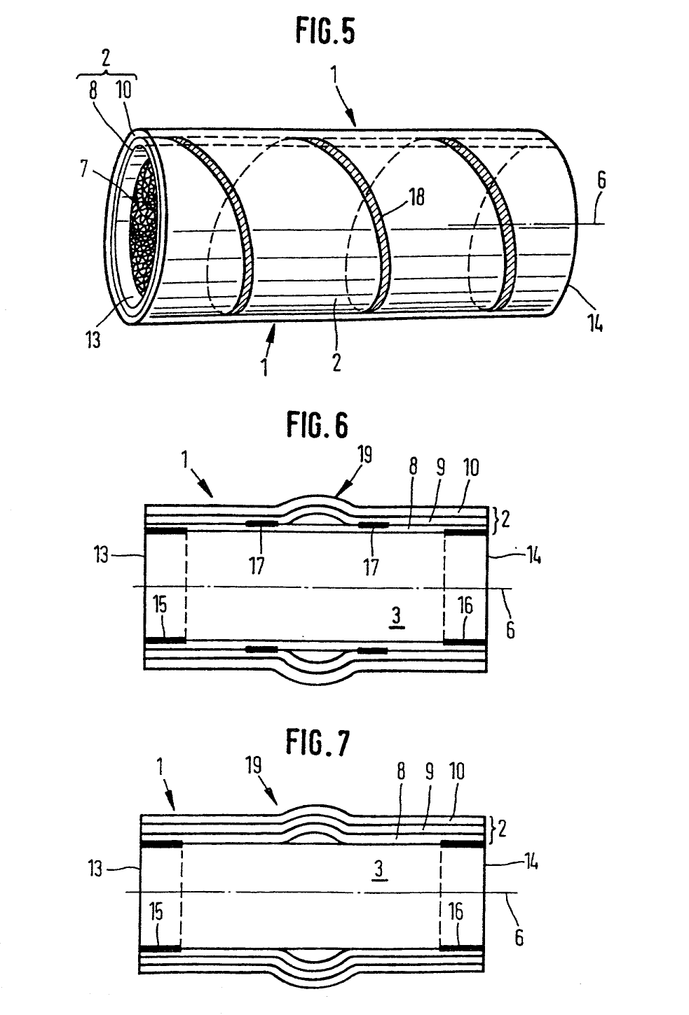

FIG. 5 shows a diagrammatic, perspective illustration of an alternative way of securing the layers 8, 10. In this case, the innermost layer 8 of the carrier-matrix shell 2 is connected to the adjoining outer layer 10 of the carrier-matrix shell 2 in one or more connecting sections 18 which are disposed asymmetrically with respect to the longitudinal axis 6 and extend helically over the axial length (L) of the honeycomb body 1. As an alternative to the illustration shown in the drawing, securing in this way may also take place only in regions, in particular over a partial angular region.

In particular, FIG. 4 shows that the connecting sections 17, 18 which are disposed between the layers 8, 10 of the carrier-matrix shell 2 are separated as far as possible from the connecting sections 15, 16 of the carrier matrix 3 at the innermost layer 8. This advantageously allows expansion of the components of the honeycomb body 1 by different amounts, in particular in the longitudinal axial direction, without this being to the detriment of permanent securing of the carrier matrix to the shell. Symmetrical and asymmetrical connecting sections may also differ from layer to layer. For example, a carrier-matrix shell having an innermost layer which is symmetrically connected to the next outer layer, while all of its other layer securing joins are asymmetric, optionally only in non-illustrated regions, may equally well have good vibration and sound-absorbing characteristics and the capacity for thermal expansion.

FIG. 6 shows a further securing alternative. In this case, with the exception of the innermost layer 8, the layers 9, 10 of the carrier-matrix shell 2 are connected to one another in a form-locking manner, preferably through the use of at least one interlocking bead 19, for example through the use of an outer bead 19 as shown. The layers 9, 10 which have been interconnected in this way are connected to the innermost layer 8 through the use of a joining technique in symmetrical connection regions 17 disposed adjacent the bead 19. A preferred manufacturing sequence provides firstly for careful securing of the carrier matrix 3 and the innermost layer 8, which are then positioned in the outermost layers 9 and 10, that have preferably been prefabricated as a unitary intermediate product, and are connected through the use of a joining technique.

Of course, it is also possible, as illustrated in FIG. 7, for all of the layers 8, 9, 10 of the carrier-matrix shell 2 to be connected to one another in a form-locking manner, preferably through the use of at least one interlocking bead 19. In this case the carrier matrix 3 is once again secured to the innermost layer 8 of the multilayer carrier-matrix shell 2 through the use of a joining technique, preferably through connecting sections 15, 16 disposed adjacent both end sides 13, 14.

All of the connection principles, which have been explained merely by way of example, advantageously allow the individual components of the honeycomb body 1 to expand by different amounts, in particular in the longitudinal axial direction, according to the extent of thermal load acting on them.

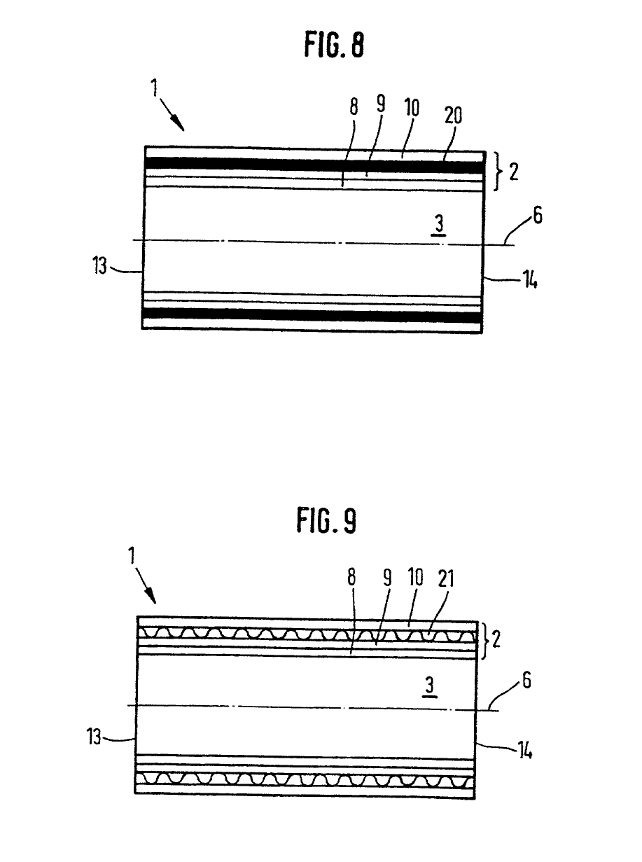

FIG. 8 shows a honeycomb body 1 in which a thin interlayer 20, that is approximately 0.5 to 0.8 mm thick and preferably is formed of a ceramic material, especially a swellable mat, is disposed in particular between the two outermost layers 9, 10 of the carrier-matrix shell 2. This interlayer advantageously absorbs resonant oscillations and advantageously ensures a certain press fit, in particular in the case of form-locking connections.

FIG. 9 shows a honeycomb body 1 in which a compensator 21, that has a loop-shaped structure in an axial longitudinal section and likewise absorbs particularly resonant oscillations, is disposed in particular between the two outermost layers 9, 10 of the carrier-matrix shell 2. Compensator and swelling elements may also be used in combination, particularly in the case of carrier-matrix shells having a multilayer structure.

The layers 8, 9, 10 of the carrier-matrix shell 2 according to the invention preferably have a thickness which is less than 1.5 times the thickness of the metal foils 4, 5, in particular a thickness which is less than 1.25 times the thickness of the metal foils 4, 5, and preferably a thickness which is identical to that of the metal foils 4, 5. Therefore, working on the basis of current metal foils, the layers 8, 9, 10 of the carrier-matrix shell 2 are preferably less than or equal to 0.5 mm thick, in particular less than or equal to 0.4 mm thick, preferably less than or equal to 0.3 mm thick. The layer thicknesses which are highly diagrammatically illustrated in FIGS. 1 to 11 therefore do not correspond to actual conditions, but rather are used to improve the clarity of the illustration. The decisive advantage when using metal foils for the carrier matrix 3 which are virtually as thin as those used for the shell 2, is that these components 2, 3, which can be connected very easily through the use of a joining technique and/or in a form-locking manner, have the same expansion characteristics. In other words, these components 2, 3 expand to the same extent, so that the connecting sections 15, 16, 17, 18 are subject to scarcely any thermal stresses.

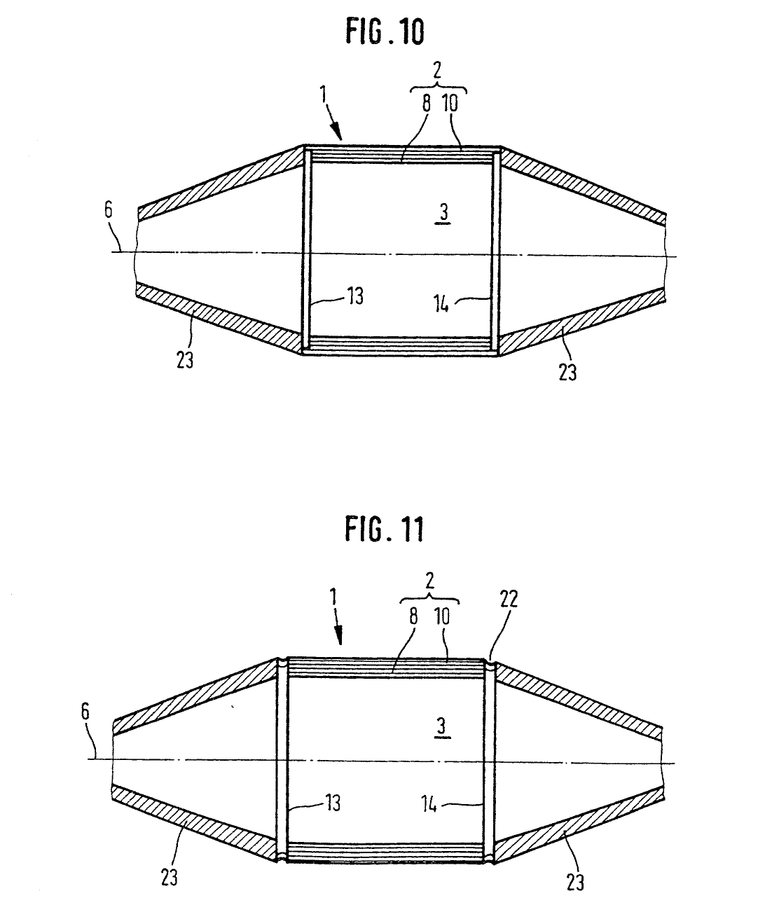

The carrier-matrix shell 2 in accordance with the exemplary embodiment shown in FIG. 10 has four separate, smooth layers, which are disposed concentrically with respect to one another, have substantially the same thickness and bear directly against one another. In order to facilitate securing to a cone 23, the outermost layer 10 is slightly longer in the axial direction than the inner layer 8, 9 of the carrier-matrix shell 2.

Alternatively, as illustrated in FIG. 11, it is possible for all of the layers of the carrier-matrix shell 2 to have the same length, in which case at least the outermost layer 10, at the end side, has a securing bead 22 in each case, to facilitate securing to a cone 23. The beads 22 could also be constructed at the same time in such a non-illustrated way that the carrier matrix 3 is held in a form-locking manner as an alternative or in addition to securing through the use of a joining technique.

The cone 23 preferably has a wall thickness which is such that the carrier-matrix shell 2 composed of the layers 8, 9, 10 is covered at the end sides.

The innermost layer 8 of the carrier-matrix shell 2 may preferably be produced from a stainless steel which is resistant to hot gas corrosion or at least is coated or plated on the inner side with such a material and/or the outermost layer 10 of the carrier-matrix shell 2 may be produced from a stainless steel which is resistant to wet corrosion or at least is coated or plated on the outer side with such a material. In that case, it is possible to additionally increase the product service life of a honeycomb body 1.

In addition to its excellent ability to compensate for thermal expansion to a much greater extent, the honeycomb body 1 according to the invention is distinguished in particular by its good vibration and sound-absorbing properties. This is due to the advantageous multilayer structure of its carrier-matrix shell 2.

I claim:

1. A honeycomb body, comprising:
a central longitudinal axis;
a carrier matrix at least one of layered, wound and folded from at least partially structured metal foils, said carrier matrix having a multiplicity of fluid-conducting passages substantially parallel to said central longitudinal axis;
a carrier-matrix shell for said carrier matrix, said carrier-matrix shell having at least two individual, smooth, mutually concentric layers, said layers of said carrier-matrix shell including at least two layers bearing directly against one another, said layers of said carrier-matrix shell only being regionally interconnected, permitting expansion of said layers by mutually different amounts, and said layers of said carrier-matrix shell being individually connected to one another by a joining technique, at least in a partial region located substantially at a location otherwise having highest vibrational amplitudes.

2. The honeycomb body according to claim 1, wherein said layers of said carrier-matrix shell expand in longitudinal axial direction.

3. The honeycomb body according to claim 1, wherein said layers of said carrier-matrix shell include an innermost layer, and said metal foils have ends interconnected only at said innermost layer in at least one connecting section.

4. The honeycomb body according to claim 3, which further comprises a fluid inlet-side end of the honeycomb body, said at least one connecting section disposed adjacent said fluid inlet-side end.

5. The honeycomb body according to claim 3, wherein said ends of said metal foils are additionally connected to said innermost layer in a further connecting section, for avoiding telescoping of said carrier matrix.

6. The honeycomb body according to claim 5, which further comprises a fluid outlet-side end of the honeycomb body, said further connecting section disposed adjacent said fluid outlet-side end.

7. The honeycomb body according to claim 3, which further comprises an axial length of the honeycomb body, said ends of said metal foils being connected to said innermost layer of said carrier-matrix shell entirely over said axial length.

8. The honeycomb body according to claim 7, wherein said axial length is less than 60 mm.

9. The honeycomb body according to claim 1, which further comprises connections between said layers of said carrier-matrix shell at least in partial regions, said connections selected from the group consisting of welded, brazed and adhesively bonded connections.

10. The honeycomb body according to claim 9, wherein said layers of said carrier-matrix shell include an innermost layer and a next outer layer, and said innermost layer is connected to said next outer layer in a connecting section disposed symmetrically relative to said longitudinal axis.

11. The honeycomb body according to claim 9, wherein said layers of said carrier-matrix shell include an innermost layer, a next outer layer and a further outer layer, and said next outer layer is connected to said further outer layer in a connecting section disposed symmetrically relative to said longitudinal axis.

12. The honeycomb body according to claim 9, wherein said layers of said carrier-matrix shell include an innermost layer, a next outer layer and a further outer layer, said innermost layer is connected to said next outer layer and said next outer layer is connected to said further outer layer in a connecting section disposed symmetrically relative to said longitudinal axis.

13. The honeycomb body according to claim 10, wherein said connecting section is disposed approximately centrally in the honeycomb body.

14. The honeycomb body according to claim 11, wherein said connecting section is disposed approximately centrally in the honeycomb body.

15. The honeycomb body according to claim 12, wherein said connecting section is disposed approximately centrally in the honeycomb body.

16. The honeycomb body according to claim 9, wherein said layers of said carrier-matrix shell include an innermost layer, a next outer layer and a further outer layer, and said next outer layer is connected to at least one of said innermost layer and said further outer layer in at least one connecting section disposed asymmetrically relative to said longitudinal axis.

17. The honeycomb body according to claim 10, wherein said metal foils have ends interconnected at said innermost layer in at least one connecting section and additionally in a further connecting section, and said connecting sections disposed between said layers of said carrier-matrix shell are separated as far as possible from said connecting sections between said ends of said metal foils and said innermost layer.

18. The honeycomb body according to claim 11, wherein said metal foils have ends interconnected at said innermost layer in at least one connecting section and additionally in a further connecting section, and said connecting sections disposed between said layers of said carrier-matrix shell are separated as far as possible from said connecting sections between said ends of said metal foils and said innermost layer.

19. The honeycomb body according to claim 12, wherein said metal foils have ends interconnected at said innermost layer in at least one connecting section and additionally in a further connecting section, and said connecting sections disposed between said layers of said carrier-matrix shell are separated as far as possible from said connecting sections between said ends of said metal foils and said innermost layer.

20. The honeycomb body according to claim 16, wherein said metal foils have ends interconnected at said innermost layer in at least one connecting section and additionally in a further connecting section, and said connecting sections disposed between said layers of said carrier-matrix shell are separated as far as possible from said connecting sections between said ends of said metal foils and said innermost layer.

21. The honeycomb body according to claim 1, wherein said layers of said carrier-matrix shell include an innermost layer, a next outer layer and a further outer layer, said layers of said carrier-matrix shell are form-lockingly connected to one another with the exception of said innermost layer, and said form-lockingly connected layers are connected to said innermost layer by a joining technique.

22. The honeycomb body according to claim 21, wherein said layers of said carrier-matrix shell, with the exception of said innermost layer, are each form-lockingly connected to one another by at least one bead.

23. The honeycomb body according to claim 1, wherein said layers of said carrier-matrix shell include an innermost layer, a next outer layer and a further outer layer, and all of said layers of said carrier-matrix shell are form-lockingly connected to one another.

24. The honeycomb body according to claim 23, wherein all of said layers of said carrier-matrix shell are each form-lockingly connected to one another by at least one bead.

25. The honeycomb body according to claim 21, which further comprises an interlayer approximately 0.5 to 0.8 mm thick disposed between two layers of said carrier-matrix shell.

26. The honeycomb body according to claim 23, which further comprises an interlayer approximately 0.5 to 0.8 mm thick disposed between two layers of said carrier-matrix shell.

27. The honeycomb body according to claim 25, wherein said interlayer is formed of a ceramic material.

28. The honeycomb body according to claim 26, wherein said interlayer is formed of a ceramic material.

29. The honeycomb body according to claim 25, wherein said interlayer is a swellable mat.

30. The honeycomb body according to claim 26, wherein said interlayer is a swellable mat.

31. The honeycomb body according to claim 21, which further comprises a compensator having a loop-shaped structure in an axial longitudinal section, said compensator disposed between two of said layers of said carrier-matrix shell.

32. The honeycomb body according to claim 23, which further comprises a compensator having a loop-shaped structure in an axial longitudinal section, said compensator disposed between two of said layers of said carrier-matrix shell.

33. The honeycomb body according to claim 1, wherein said metal foils have a given thickness, said layers of said carrier-matrix shell include an innermost layer, and at least said innermost layer has a thickness of less than 1.5 times said given thickness.

34. The honeycomb body according to claim 1, wherein said metal foils have a given thickness, said layers of said carrier-matrix shell include an innermost layer, and at least said innermost layer has a thickness of less than 1.25 times said given thickness.

35. The honeycomb body according to claim 1, wherein said metal foils have a given thickness, said layers of said carrier-matrix shell include an innermost layer, and at least said innermost layer has a thickness approximately equal to said given thickness.

36. The honeycomb body according to claim 1, wherein said layers of said carrier-matrix shell are at most 0.05 mm thick.

37. The honeycomb body according to claim 1, wherein said layers of said carrier-matrix shell are at most 0.04 mm thick.

38. The honeycomb body according to claim 1, wherein said layers of said carrier-matrix shell are at most 0.03 mm thick.

39. The honeycomb body according to claim 1, wherein said layers of said carrier-matrix shell include an outermost layer and at least one inner layer, and said outermost layer is longer in axial direction than said at least one inner layer.

40. The honeycomb body according to claim 1, wherein said layers of said carrier-matrix shell include an innermost layer and at least one outer layer including an outermost layer, all of said layers have an equal length, and at least said outermost layer has an end side with a securing bead.

41. The honeycomb body according to claim 39, wherein said outermost layer has end-side ends, and cones are each disposed at a respective one of said end-side ends.

42. The honeycomb body according to claim 40, wherein said outermost layer has end-side ends, and cones are each disposed at a respective one of said end-side ends.

43. The honeycomb body according to claim 41, wherein said cones are connected to said end-side ends by a joining technique.

44. The honeycomb body according to claim 42, wherein said cones are connected to said end-side ends by a joining technique.

45. The honeycomb body according to claim 41, wherein said carrier-matrix shell has end sides, and said cones have wall thicknesses covering said end sides of said carrier-matrix shell.

46. The honeycomb body according to claim 42, wherein said carrier-matrix shell has end sides, and said cones have wall thicknesses covering said end sides of said carrier-matrix shell.

47. The honeycomb body according to claim 1, wherein said layers of said carrier-matrix shell include an innermost layer formed of a stainless steel resistant to corrosion from hot gases.

48. The honeycomb body according to claim 1, wherein said layers of said carrier-matrix shell include an innermost layer having an inner surface, and at least said inner surface has a material selected from the group consisting of a stainless steel coating and a stainless steel plating resistant to corrosion from hot gases.

49. The honeycomb body according to claim 1, wherein said layers of said carrier-matrix shell include an outermost layer formed of a stainless steel resistant to wet corrosion.

50. The honeycomb body according to claim 1, wherein said layers of said carrier-matrix shell include an outermost layer having an outer surface, and at least said outer surface has a material selected from the group consisting of a stainless steel coating and a stainless steel plating resistant to wet corrosion.

51. The honeycomb body according to claim 1, wherein said layers of said carrier-matrix shell include an innermost layer formed of a stainless steel resistant to corrosion from hot gases and an outermost layer formed of a stainless steel resistant to wet corrosion.

52. The honeycomb body according to claim 1, wherein said layers of said carrier-matrix shell include an innermost layer having an inner surface and an outermost layer having an outer surface, at least said inner surface of said innermost layer has a material selected from the group consisting of a stainless steel coating and a stainless steel plating resistant to corrosion from hot gases, and at least said outer surface of said outermost layer has a material selected from the group consisting of a stainless steel coating and a stainless steel plating resistant to wet corrosion.

53. A catalyst carrier body, comprising:
a central longitudinal axis;
a carrier matrix at least one of layered, wound and folded from at least partially structured metal foils, said carrier matrix having a multiplicity of fluid-conducting passages substantially parallel to said central longitudinal axis;
a carrier-matrix shell for said carrier matrix, said carrier-matrix shell having at least two individual, smooth, mutually concentric layers, said layers of said carrier-matrix shell including at least two layers bearing directly against one another, said layers of said carrier-matrix shell only being regionally interconnected, permitting expansion of said layers by mutually different amounts, and said layers of said carrier-matrix shell being individually connected to one another by a joining technique, at least in a partial region located substantially at a location otherwise having highest vibrational amplitudes.
